(19) United States
(12) Patent Application Publication
(10) Pub. No.: US 2010/0306930 A1
(43) Pub. Date: Dec. 9, 2010

(54) LIFTABLE VEHICLE

(75) Inventor: Franco Cesarini, Albano Laziale (RM) (IT)

Correspondence Address: KNOBBE MARTENS OLSON & BEAR LLP, 2040 MAIN STREET, FOURTEENTH FLOOR, IRVINE, CA, 92614, US

(73) Assignee: AIRPORT EQUIPMENT SRL, Albano Laziale (RM) (IT)

(21) Appl. No.: 12/682,239

(22) PCT Filed: Oct. 6, 2008
(86) PCT No.: PCT/IT08/00632

§ 371 Date: Aug. 9, 2010

(30) Foreign Application Priority Data
Oct. 8, 2007 (IT) RM2007A000530

(51) Int. Cl. B64F 1/31; B60P 1/02; A61G 3/06; E01D 1/00

(52) U.S. Cl. 14/72.5; 414/495

(57) ABSTRACT

A liftable vehicle provided with a single cab wherein both the operator/driver of the vehicle and the load and/or passengers (in general, disabled persons) are positioned. The cab is operatively connected with a flatbed bearing the engine and the means for lifting the cab with respect to said flatbed. The vehicle is further provided with platforms/gangways for boarding and disembarking persons or for loading and unloading cargo in general and/or in particular for use in airports.

### FIELD OF THE INVENTION

The present invention relates to a liftable vehicle provided with a single cab in which are positioned both the operator/driver of the vehicle and the load and/or passengers (in general, disabled persons). The cab is operatively connected with a flatbed bearing the motorization and the means for lifting the cab relative to said flatbed. The vehicle is further provided with platforms/gangways for boarding and disembarking persons or for loading and unloading cargo in general and/or in particular for use in airports.

### BACKGROUND ART

Existing transport means (motor vehicles in general, trucks, buses, etc.) have the body platform at an average height from the ground of about 0.5-1.7 m. For cargo or persons, in particular disabled persons, to enter the transport vehicle, external equipment is used, such as forklifts and/or movable platforms actuated by hydraulic devices, described for example in FR 2.878.433, GB 2.202.202, CA 2.217.454. Such external equipment, which is normally situated in the lateral-posterior part of the vehicle, may or may not be incorporated on the transport means itself.

Another type of embodiment is described in EP 1 161 365, wherein the vehicle described is provided with a system for loading/unloading cargo and/or persons and comprises a cab for the driver and an elevating body to take passengers and/or cargo, which can be raised with respect to the frame of the vehicle.

In the embodiment described EP 1 161 365, both loading and unloading operations (of cargo or persons) are carried out using the front opening of the housing body. An extensible gangway, operatively connected with the driver's cab, assists in the loading and unloading operations of persons and things.

The aforementioned transport vehicles present some drawbacks, such as their overall dimensions, which, in the whole, are large.

Moreover, the operator, who is generally is also the driver of the vehicle, must attend to its movement, to the execution and control of the numerous operations related to the raising of the elevating housing body, to the movement of the front and possibly rear gangways; additionally, the operator must watch over the correct boarding and the correct disembarking of the passengers or correct loading and unloading of cargo and certainly does not have a complete control of the passenger or of the cargo, which are placed behind the driver's seat, thus at the back of the driver, inside the housing body, in particular in the case when the driver's cab is physically separated from the body. Moreover, the presence of the driver's cab entails large longitudinal dimensions of the whole vehicle which hamper maneuvers in areas of reduced extensions, e.g. those available in case of loading/unloading small aircrafts.

### SUMMARY OF THE INVENTION

An object of the present invention is to enable the operator who maneuvers the vehicle to control and closely watch over boarding and disembarking operations of passengers or loading and unloading of cargo carried out at the ground level or at the level of the entrance or loading opening of a transport means in general and of an aircraft in particular.

Another object of the present invention is to reduce the overall dimensions of a transport vehicle of the type mentioned above, optimizing available spaces without reducing its functionality.

Yet another object is to enable the operator who maneuvers the vehicle to control and closely watch over the load or the passengers during the movement and when the vehicle shifts from the loading position to the unloading position and vice versa and during the phases of raising the load itself.

According to the present invention, it is provided a liftable vehicle furnished with a single cab inside of which both the operator/driver of the vehicle and the load and/or passengers (in general, disabled persons) are placed. The cab, which preferably laterally houses the driver's station, is operatively connected with a flatbed which in turn comprises the engine for moving the vehicle and the means for lifting the cab with respect to the flatbed. The vehicle is further provided with platforms/gangways and slides for boarding and disembarking persons or for loading and unloading cargo in general and/or in particular for use in airports.

Preferably, the platforms/gangways are located in front and/or at the rear of the vehicle and can be operatively connected to the flatbed and/or to the cab.

Preferably, the driver's position is placed inside the cab and it is provided with controls of the joystick type (not shown). However, a driver's position on the exterior of the cab can be provided, consisting substantially in an operative console with remote controls. The joystick-like command is of the commercial type and it is advantageously of the “control stick” type used on aircrafts and it groups together all the operative functions of the machine, which are easily operated with a single hand, enabling the operator to accompany, position, control the load, the passenger and/or the disabled person on board of the vehicle.

According to the invention, the lifting means for lifting the cab with respect to the flatbed are preferably of the telescopic type, e.g. like those mounted on forklifts, and they can be, for example, operated hydraulically or with other conventional means, such as electric or pneumatic jacks. These lifting means can raise the cab from the level of the vehicle frame to an opening for entry and loading in general, or to the entrance door or to the loading opening of an aircraft.

Preferably, the vehicle of the invention is provided with a lowered flatbed in order for it to be placed as close to the ground as possible and it is provided with a traditional engine, e.g. electric, internal combustion or diesel engine.

Also according to the present invention, the gangway is preferably placed at the basis on the front part of the cab and is extensible towards the entrance or loading opening in general, i.e. to the entrance door or to the loading opening of an aircraft. The slide is connected to the cab and it can be raised or lowered, with manual or mechanical overturning in a known fashion, respectively when it is in use or rest position. In this overturned non-use position, it also acts as a retaining and safety side during transport and cab operation. When the cab has to be loaded, the slide is positioned in such a way as to constitute an inclined plane connecting the base of the cab to the ground. The cab can be raised with respect to the frame of the vehicle and it can be raised by way of the lifting means provided with the flatbed to a position in which the flatbed connected thereto is at the same level as the entrance door or the loading opening of the aircraft.

### DESCRIPTION OF A PREFERRED EMBODIMENT

The present invention shall now be described with reference to a currently preferred embodiment thereof. It can be easily appreciated that many modifications can be made without departing from the scope of the invention, which is explained with reference to the enclosed figures, in which:

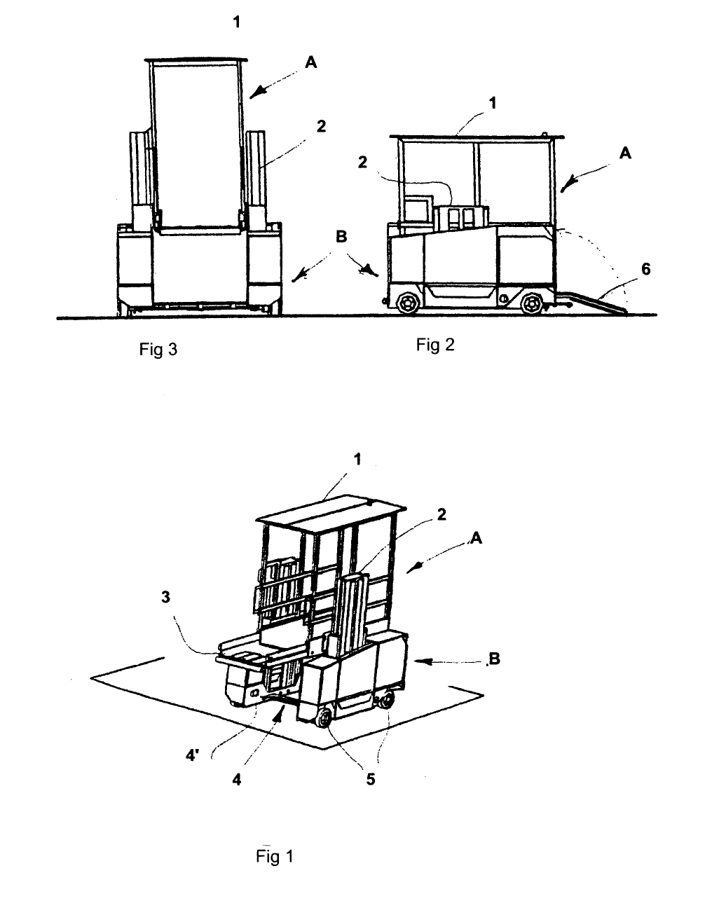

FIG. 1 shows a schematic perspective view of the liftable vehicle according to the invention in a position in which the cab A is raised with respect to the flatbed B;

FIG. 2 shows a schematic lateral view of the vehicle according to FIG. 1 in a position in which the cab A is lowered on the flatbed B;

FIG. 3 shows a schematic front view of the vehicle of FIG. 1;

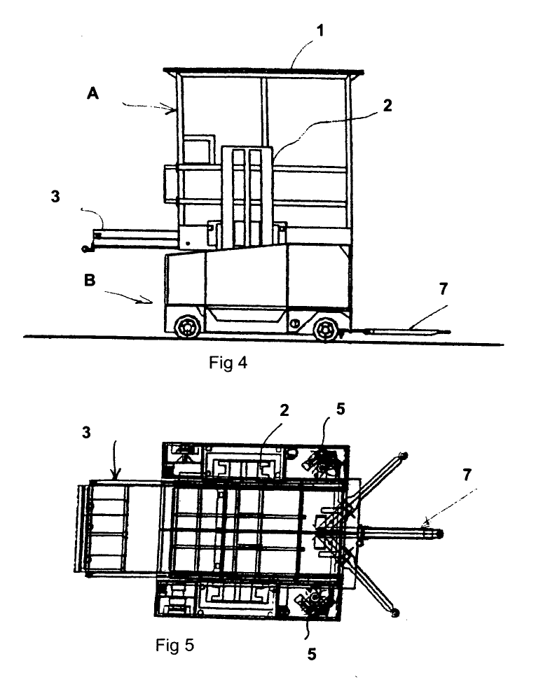

FIG. 4 shows a schematic lateral view of the vehicle of FIG. 1;

FIG. 5 shows a schematic top view of the vehicle of FIG. 1.

With reference to the figures, in FIG. 1 the liftable vehicle according to the invention is shown in its entirety. Therein, the reference letter A generically indicates the cab that houses both the driver and the load (passengers or cargo). The driver's position is preferably a standing one possibly provided with a high seat. The joystick-like operating means (not shown) are positioned laterally, e.g. on the right side with respect to the travelling direction, in the direction of travel, inside an operative panel, generally at waist height. Alternatively, the operating means can be constituted by a remote operative console.

The cab A can be completely open or can have an upper roof 1 and can be, if needed, provided with windows. The cab A is raised with a lifting system 2 which can advantageously be a conventional telescopic lifting system.

The cab A, preferably provided with a front and a rear opening for entrance and exit, is also provided with an extensible gangway 3 preferably mounted at the opening of the front part of the vehicle and extensible longitudinally to rest on and align with an opening for entrance or loading in general, i.e. to the door for entrance or loading of an aircraft (not shown). The gangway 3 dimensions are such that in its retracted position it remains within the shape and the maximum size of the vehicle, whilst when it is in its extended position if projects outside the dimensions of the vehicle creating a projecting element such as to enable an easy alignment for a safe transfer to and from the aircraft.

To the cab A is also hinged a board 6 in the form of a slide, preferably in opposite position with respect to the gangway 3. The board or slide 6 constitutes an inclined plane that connects the base of the cab A to the ground to facilitate the loading of cargo and/or the entrance of persons. The board 6 constitutes the overturnable access ramp for positioning the cargo or the disabled passenger in a wheelchair or on stretchers which can be so operated from the ground up to boarding, easily overcoming the step between the flatbed B and the ground. The board or slide 6 can be overturned manually or mechanically to return within the shape of the vehicle and constitute a retaining and safety side during the transportation and/or the vertical movement of the cab A itself.

The flatbed B is provided with a frame 4 mounted on wheels generically indicated with 5. The flatbed B present with a rearward configuration 4′ with respect to the front wheels of the flatbed B. This configuration allows for a facilitated maneuvering and operativity of the vehicle, especially in combination with the gangway 3. As a matter of fact this particular configuration of the frame cooperates with the gangway to enable boarding and disembarking, especially of disabled persons, into/out of small aircrafts of the “commuter” type that have an overturnable access ladder included in the access door itself. For example in these aircrafts disabled persons could not be embarked without requiring transfers or additional lifting means.

The vehicle may also be provided with towing bar 7 which can be disassemble a positioned on the frame 4, preferably at the rear end. Since the vehicle of the invention is generally provided with a small engine and reaches very low speeds (typically, below 10 kg/h), the distance it can cover are very shorts, so that the bar 7 can advantageously be used to tow the vehicle if long distances are to be covered. When it is not needed, the bar 7 can be disassembled and positioned in a housing that is preferably provided within the lateral fairings.

In a variant not shown herein, the extensible gangway 3 is built in such a way as to incorporate both the functions of a gangway extensible towards the aircraft and junction board or slide between the ground and the base of the cab A, which in this arrangement may advantageously present a single access opening.

With regards to the operation of the liftable vehicle according to the invention, the operator, who drives the vehicle from inside the cab A, approaches the aircraft in its flying arrangement and in its proximitiy (s)he gets prepared, for example, for any operation of loading or unloading cargo, persons or a disabled person. At this time, the operator maneuvers the lifting system 2 until the front part of the transport vehicle, together with the raising cab A, reaches the cargo compartment or the door of the aircraft. From the opening on the front part of the cab A the gangway 3 is sent out until it rests on the aircraft or on another entry and loading opening so that cargo, passengers, trolleys or wheelchairs for disabled persons can walk on the gangway 3 to exit from, or to be housed in the cab A. In case of aircrafts with an incorporated ladder, said ladder can advantageously be incorporated within the compartment obtained between the frame 4, moved rearwards in 4′, and the gangway 3 in its extended disposition, enabling a safe transfer.

The operator checks that the operations proceed correctly without moving from his/her position. This way, thanks to the arrangement according to the invention, a single operator can carry out the entire loading, unloading and transfer cycle.

Once cargo and/or passengers, who may be disabled persons, are in the lifting cab A, the operator, after retracting the extensible gangway 3, actuates the lifting system 2 downward until the lowest position of the cab is reached. Then the operator drives the vehicle to the place of transfer and during the travel (s)he has complete control of the cargo/passengers. Upon arrival, the operator controls the lowering of the board or slide 6 to its lowest position in contact with the ground, as shown in FIG. 2, and the cargo or the passengers move from the cab A to the ground using the board or slide 6.

It is clear that, according to the invention, all these operations can take place with the utmost comfort and safety for those who are transported because they require only few essential operations which are all under the direct supervision of the operator who, from his/her driver's position on one side in cab A, controls the transported cargo or persons and the surrounding environment and the one external to the cab.

The vehicle of the invention is particularly advantageous for moving disabled persons and for boarding them on particular in small aircrafts, with a ladder incorporated in the entrance/exit door, which for this reason would not allow to board a disabled person with known means. These advantages are achieved thanks to the fitting of the vehicle. Actually, thanks to the combination of the frame 4 in rear position in 4′ and of the extended gangway 3, a compartment is created which incorporates the bulk of the aircraft ladder, thus enabling the boarding of the disabled person who from the cab A of the vehicle can be moved into the aircraft along the plane provided by the gangway 3.

Moreover, thanks to the combination of the cab A provided with an internal drive with joystick, the lowered flatbed 4, the extensible front and of the rear slide 6, the disabled person is easily picked up from the ground and moved to the maximum operating height and hence inside the aircraft with no need for further transfers or additional lifting systems and operating devices.

A further advantage of the vehicle of the invention is due to the positioning of the driver's seat, advantageously with a joystick, inside the cab in which the transported cargo or person is housed. This arrangement enables the operator to drive and simultaneously also control the transported cargo or person, making its or his/her travel safe on the route between the loading and the unloading area.

Yet another advantage of the vehicle of the present invention relates to its compactness, provided by the positioning of the driver's position inside the cab A, which thus enables its use in areas of reduced dimensions, such as those of small aircrafts.

1. A vehicle for transporting and lifting a cargo and/or a person to an entrance or a loading opening comprising:
a flatbed comprising frame; and,
a cab,
wherein said cab can be raised by any lifting system from a level of the frame of the flatbed (B) and comprises a gangway extensible towards the entrance or the loading opening;
wherein said cab further comprises a board or a slide hinged to the cab itself, in such a way as to constitute an inclined plane to connect a basis of the cab to a ground to facilitate an entry/exit of a load into/out of said cab without an additional transfer;
wherein said cap further comprises a driver's station.

2. A vehicle according to claim 1, wherein the driver's station is placed on oneside within said cab and comprises joystick-like controls.

3. A vehicle according to claim 1, wherein the driver's station comprises a remote operating console.

4. Vehicle according to claim 1, wherein the board or the slide hinged to said cab is placed in opposite to the extensible gangway.

5. A vehicle according to claim 1, wherein the board or the slide hinged to said cab can be overturned in such a way as to function as a retaining and safety side during transportation and vertical movement.

6. A vehicle according to claim 1, wherein said cab, an opening with the gangway and an opening with the slide constitute a single compartment for a driver and for transportation and movement of the cargo.

7. A vehicle according to claim 1, wherein the flatbed comprises front wheels and the frame has a rearward configuration with respect to the front wheels of the flatbed in such a way as to allow that, in combination with the gangway in its extended position, a compartment is created that incorporates an access ladder of the aircraft.

8. A vehicle according to claim 1, further comprising a removable bar, placed on the flatbed, for towing the vehicle.

9. A vehicle according to claim 1, wherein the vehicle is configured to pick the load up from the ground and move the load to a maximum operating height of the vehicle with no need for further transfers or for additional lifting using additional moving systems or devices.

10. A vehicle according to claim 1, wherein a position of the driver's station with a joystick, within said cab enables an operator to drive and simultaneously control the load, making its transportation safe during a route from a loading area to a unloading area.

11. A vehicle according to claim 1, wherein the extensible gangway functions as the board or the slide connecting the ground to the basis of the cab, thereby providing a single access opening.

12. A vehicle according to claim 1, wherein the entrance or the loading opening is an entrance door or a loading opening of an aircraft, the aircraft comprising a front and/or rear opening for boarding and disembarking the person and/or for loading and unloading the cargo.
